(19) United States
(12) Patent Application Publication
(10) Pub. No.: US 2026/0203784 A1
(43) Pub. Date: Jul. 16, 2026

(54) PROVIDING PERSONALIZED INCENTIVES FOR BUNDLING ACTIVITIES

(71) Applicant: American Express Travel Related Services Company, Inc., New York, NY (US)

(72) Inventors: Yue Xi, Old Bethpage, NY (US); Conor R. Hughes, Scottsdale, AZ (US); Apurva Srivastava, Phoenix, AZ (US); Manasa Vasudev, Mckinney, TX (US); Sri Rajendra Pedamallu, Phoenix, AZ (US); Anastasiia Kopylova, Angier, NC (US); Ashley Rousseau, Miami, FL (US); Karen A. Reeves, Phoenix, AZ (US); Yash Arora, Scottsdale, AZ (US); Felicia Fiore, Mount Vernon, NY (US); Montaque C. Runnion, Phoenix, AZ (US); Smitha Paudel, Pheonix, AZ (US); Swati Dewan Kapoor, Gurugram (IN); Jessica Kathryn Circuit, Scottsdale, AZ (US); Errol Ng, Queens, NY (US); Samantha A. Meehan, Manhattan, NY (US); Manjesh Kumar Savita, Pheonix, AZ (US); James Lee Abbott, Mart, TX (US)

(21) Appl. No.: 19/565,772

(22) Filed: Mar. 13, 2026

Related U.S. Application Data
(63) Continuation of application No. 18/419,489, filed on Jan. 22, 2024.

(51) Int. Cl. G06Q 30/0207

(52) U.S. Cl. CPC G06Q 30/0207

(57) ABSTRACT

Disclosed are various approaches for providing incentive programs for certain kinds of activities conducted in a client account. A selection of a first record from a plurality of records presented through a user interface is received. Then a message is sent to a program service, the message comprising record data associated with the first record. Next, a program-qualified subcategory of the plurality of records and a program-unqualified subcategory of the plurality of records is obtained from the program service. Subsequently, the plurality of records in the user interface is automatically arranged based at least in part on the program-qualified subcategory and the program-unqualified subcategory.

### CROSS-REFERENCE TO RELATED APPLICATION

This application is a continuation of, and claims priority to and the benefit of, U.S. patent application Ser. No. 18/419,489, and entitled “PROVIDING PERSONALIZED INCENTIVES FOR BUNDLING ACTIVITIES,” and filed Jan. 22, 2024, which is incorporated by reference herein in its entirety for all purposes.

### BACKGROUND

Many organizations may wish to provide their customers special incentives for engaging in different kinds of activities. However, it may be difficult for an organization to track eligibility of a customer's activities for different benefits and incentive programs. Additionally, it can be challenging to present customers with personalized programs based on the specific customer's activity. Therefore, customers and organizations alike may encounter difficulty in identifying and engaging with different kinds of program-qualified activities.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a pictorial diagram of an example user interface rendered by a client according to various embodiments of the present disclosure.

FIG. 2 is a pictorial diagram of an example user interface rendered by a client according to various embodiments of the present disclosure.

FIG. 3 is a drawing of a network environment according to various embodiments of the present disclosure.

FIG. 4 is a flowchart illustrating one example of functionality implemented as portions of an application executed in a computing environment in the network environment of FIG. 3 according to various embodiments of the present disclosure.

FIGS. 5A and 5B are flowcharts illustrating one example of functionality implemented as portions of an application executed in a computing environment in the network environment of FIG. 3 according to various embodiments of the present disclosure.

### DETAILED DESCRIPTION

Disclosed are various approaches for providing incentive programs for certain kinds of activities conducted in a client account. Traditionally, bundling incentive programs are provided to customers or clients in a user interface in a manner which requires a client to search through a plurality of activity records and make subjective selections for bundling activities. This presentation is inefficient and cumbersome for clients and may result in missed opportunities for engagement with different benefits and incentive programs.

In contrast to other approaches, the approaches herein use client-specific records of actions and corresponding record data in combination with specific qualification criteria for incentive programs to provide customers or clients with personalized and more effective presentation of incentive programs. Additionally, the approaches herein use various methods of presenting incentive programs and records to customers or clients in user interfaces and methods for automatically arranging and rearranging the presentation of relevant records to clients. In some examples, a program is specifically targeted based at least in part on the client account and the associated action records. Based at least in part on the program and its corresponding qualification criteria, the action records can be automatically presented to the client in a manner which visually simplifies the distinction between different qualified and un-qualified records.

For example, when a client wishes to bundle one or more action records, a personalized program can be recommended in a banner on a user interface. The client can then be provided with groups of qualified and unqualified records which could be bundled under the personalized program. As the client interacts with the program and various records, the presentation and availability of interactions with other records can automatically change to emphasize certain records. Thus, various embodiments of the present disclosure can save valuable time and resources in identifying and engaging with various benefit and incentive programs for bundling activities.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

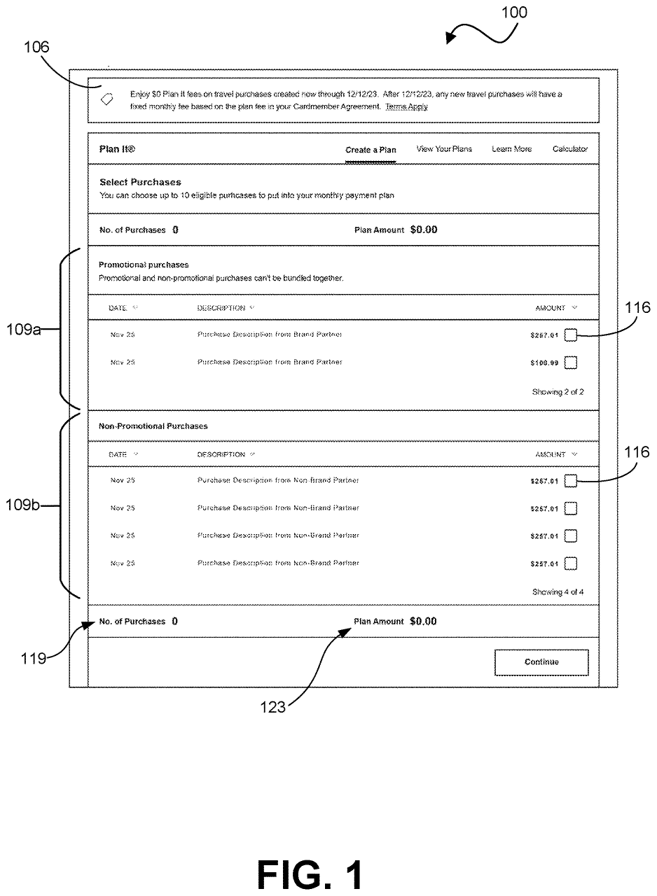

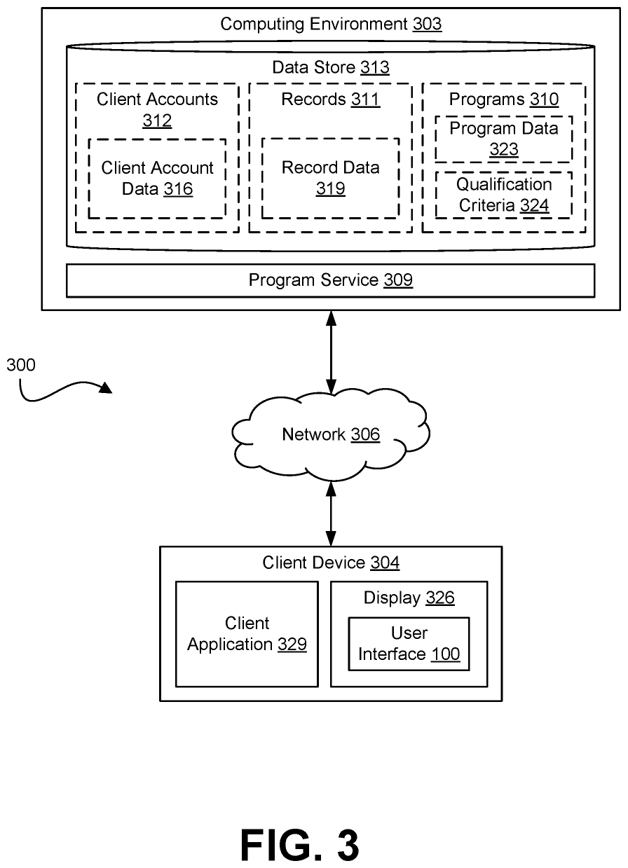

FIG. 1 depicts an example user interface 100 of a client device 304 (FIG. 3) according to various embodiments of the present disclosure. The user interface 100 can show information associated with a client transaction account 312, described further in the discussion of FIG. 3. This information can include a plurality of records 311 of transactions associated with the client account 312, a banner 106 showing various information about an applicable program, as well as other information, described further in the discussion of FIG. 3, and user interface elements. Additionally, information associated with individual records 311, such as an amount, a date, a counterparty in a transaction (e.g., merchant, vendor, service provider, etc.), or a description of a record 311, can be presented in the user interface 100. In some embodiments, the plurality of records 311 can be presented in one or more categories 109 (e.g., 109a, 109b, etc.). A first program-qualified category 109a can include records 311 which meet various qualification criteria 324 for a certain program 310, as described further in the discussion of FIG. 3. A second program-unqualified category 109b can include records 311 which fail to meet various qualification criteria 324 for the program 310. In some cases, the user interface 100 can present records 311 in further categories based at least in part on whether the records 311 meet qualification criteria 324 for multiple different programs 310. For example, the transaction records 311 can be presented in a first category 109a of records which are qualified for a first program 310a, a second category 109b of records which are qualified for a second program 310b, and a third category 109c of records which are not qualified for either program 310a, 310b. According to some embodiments, the records 311 can be presented in categories based at least in part on the program 310 described in the banner 106.

In some embodiments, the user interface 100 includes one or more interactive user interface elements 116 corresponding to individual records 311. These user interface elements 116 can be checkboxes, radio buttons, toggles, or other user interface elements. The user interface 100 can further include information related to the records 311 which have been selected, such as the number of records selected 119, the total value of the records selected 123, as well as other information. This information can be updated in response to user interactions with various components in the user interface 100.

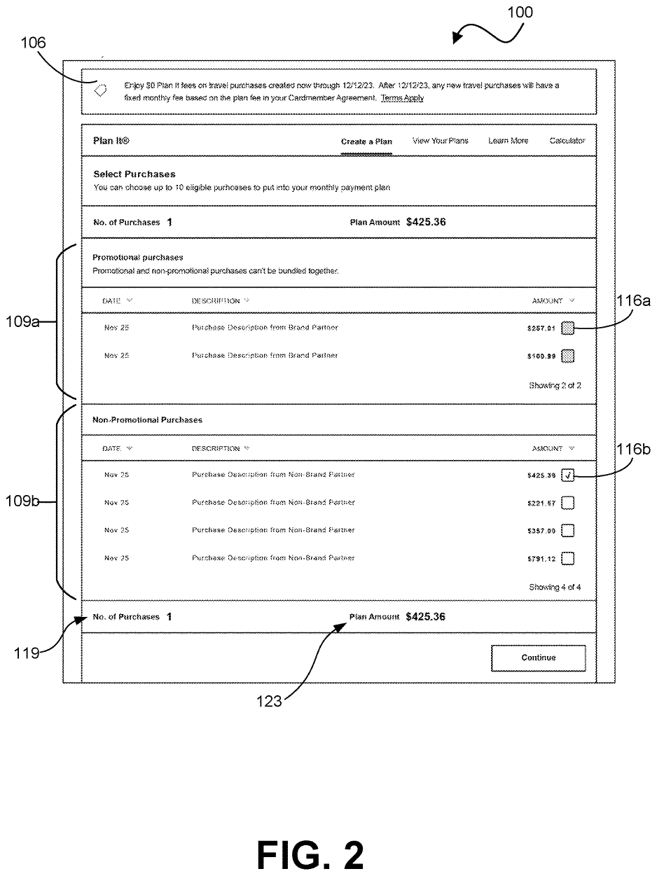

FIG. 2 depicts an example user interface 100 of a client device 304 (FIG. 3) according to various embodiments of the present disclosure. A user can interact with a user interface element 116b corresponding to an individual record 311 to select the record 311. In some embodiments, the selection of the user interface element 116b of a record 311 in one category 109b can result in a client application 329 disabling interactions with the user interface elements 116a in another category 109a. For example, as shown in FIG. 2, if a user interacts with the user interface element 116b for a record 311 in a program-unqualified category 109b, the interactions can be disabled for the user interface elements 116a in the program-qualified category 109a. Similarly, if a user interacts with a user interface element 116a for a record 311 in a program-qualified category 109a, the interactions can be disabled for the user interface elements 116b in the program-unqualified category 109b.

According to some examples, an interaction with a user interface element 116 can result in the client application 329 arranging the plurality of records 311 into categories 109 based at least in part on the qualification criteria 324 for a program 310 applicable to the record 311 associated with the selected user interface element 116. In some embodiments, the banner 106 can include an interactive user interface element 116 which, when selected by a user, can result in the client application 329 arranging the plurality of records into categories 109 based at least in part on the qualification criteria 324 for the program 310 described in the banner 106. In some embodiments, an interaction with a user interface element 116 can result in the client application 329 arranging the selected records 311 into a separate subcategory of selected records 311.

With reference to FIG. 3, shown is a network environment 300 according to various embodiments. The network environment 300 can include a computing environment 303 and a client device 304, which can be in data communication with each other via a network 306.

The network 306 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 306 can also include a combination of two or more networks 306. Examples of networks 306 can include the Internet, intranets, extranets, virtual private networks (VPNs), and similar networks.

The computing environment 303 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 303 can employ a plurality of computing devices that can be arranged in one or more server banks or computer banks or other arrangements. Such computing devices can be located in a single installation or can be distributed among many different geographical locations. For example, the computing environment 303 can include a plurality of computing devices that together can include a hosted computing resource, a grid computing resource, or any other distributed computing arrangement. In some cases, the computing environment 303 can correspond to an elastic computing resource where the allotted capacity of processing, network, storage, or other computing-related resources can vary over time.

Various applications or other functionality can be executed in the computing environment 303. The components executed on the computing environment 303 include a program service 309, and other applications, services, processes, systems, engines, or functionality not discussed in detail herein.

The program service 309 can be executed to identify and apply applicable programs 310 to the records 311 associated with a client account 312. The program service 309 can be operated by an issuer of a client account 312 (e.g., credit or charge card account, demand deposit account, stored value payment account, etc.). The program service 309 can be executed to send and receive various messages to/from other applications, determine qualifications of records 311 according to various programs 310 and separate the records 311 accordingly, and apply a program 310 to selected records 311, as well as other functionalities. Other functionalities can also be provided in various implementations.

Also, various data is stored in a data store 313 that is accessible to the computing environment 303. The data store 313 can be representative of a plurality of data stores 313, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 313 is associated with the operation of the various applications or functional entities described below. This data can include client accounts 312, records 311, programs 310, and potentially other data.

The client accounts 312 can represent any transaction account (e.g., credit or charge card account, demand deposit account, stored value payment account, etc.), rewards account, user account, or other collection of client account data 316. Client account data 316 can include data such as a client identifier, a plurality of records 311 associated with the client account 312, client settings and permissions, client type, account type, engagement history, and potentially other client account data 316. A client identifier can represent any identifier which is unique to the client. The plurality of records 311 can represent any number of records 311 initiated, received, or otherwise associated with the client account 312. A client type can represent an identifier distinguishing the type of client, such as whether the client is a person or business, a premium client, etc. Similarly, an account type can represent a distinguishing feature of the account, such as whether the account is a transaction account, rewards account, booking account, or other, as well as whether the account is a standard account, premium account, etc. An engagement history can include different metrics of engagement with the client account 312 such as the number of records 311 associated with the account and the frequency with which records 311 are made, as well as engagement with additional features offered with the client account 312.

The records 311 can represent any action or transaction made with a client account 312. Accordingly, each record 311 can include record data 319 such as a record identifier, a record type, an account identifier for the client account 312 that is associated with the record 311, an enterprise identifier for the enterprise with whom the record 311 was made, a value associated with the record 311, a time stamp of the record 311, as well as potentially other record data 319. A record identifier can represent any identifier that uniquely identifies one record 311 with respect to another. Similarly, an account identifier and an enterprise identifier can represent any identifier which uniquely identifies a respective client account 312 or enterprise from another. The record type can represent any type, category, or form of record 311, and can be used to sort records 311 accordingly. In some embodiments, the value can represent an amount of currency or currency equivalent (e.g., rewards points), or combination thereof, used to pay for or fund the record 311. The time stamp can represent the date and/or time at which the record 311 was created or authorized, or that a request to authorize the record 311 was made, depending on the implementation.

The programs 310 can represent any campaign, scheme, or offer for which different records 311 may qualify. For example, a program 310 can be a promotional advertising campaign designed to encourage a client to engage with a particular type of record 311 by offering various incentives, such as discounts, rewards, or special offers. In some embodiments, a program 310 can be a discounted fee schedule offered for all transaction records 311 associated with a particular enterprise. In some embodiments, a program 310 can be a special offer of benefits for transaction records 311 above a value threshold. In some embodiments, a program 310 can be a tiered program 310 in which the terms of the offer change as records 311 are added to the program 310. For example, a program 310 can include increasing discount rates which may apply as the overall value of selected records 311 increases. The programs 310 can include various program data 323 as well as qualification criteria 324.

Program data 323 can represent any feature or series of features which distinguish one program 310 from another. This program data 323 can include a time duration of the program 310, a discount rate or value, an award, and potentially other program data 323. A time duration of the program 310 can represent a window of availability for the program 310 during which a client can engage. A discounted rate or value can represent a reduced fee percentage rate, a fee value deduction, a cash-back offer, etc. An award can represent an incentive such as points, currency or currency-equivalent, special bundled offers, coupons, or other form of award.

Qualification criteria 324 can represent one or more various features or characteristics which must be present in a particular record 311 in order for the record to be qualified for a particular program 310. A record 311 which meets the qualification criteria 324 associated with a program 310 can be distinguished from other unqualified records 311 when presented in a user interface 100. In some embodiments, the qualification criteria 324 can include any feature which corresponds to one or more features of record data 319 associated with a record 311. For example, the qualification criteria 324 of a particular program 310 can include an enterprise qualification criterium specifying an enterprise with whom a record 311 has been created. In such a case, the enterprise qualification criterium corresponds to an enterprise identifier which may be found in the record data 319 of various records 311. Thus, when a program 310 is activated which includes an enterprise qualification criterion, any records 311 which include the corresponding enterprise identifier can be identified. In some embodiments, qualification criteria 324 can represent a series of true or false rules which can be used to identify qualified records 311.

The client device 304 is representative of a plurality of client devices that can be coupled to the network 306. The client device 304 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 304 can include one or more displays 326, such as liquid crystal displays (LCDs), gas plasma-based flat panel displays, organic light emitting diode (OLED) displays, electrophoretic ink (“E-ink”) displays, projectors, or other types of display devices. In some instances, the display 326 can be a component of the client device 304 or can be connected to the client device 304 through a wired or wireless connection.

The client device 304 can be configured to execute various applications such as a client application 329 or other applications. The client application 329 can be executed in a client device 304 to access network content served up by the computing environment 303 or other servers, thereby rendering a user interface 100 on the display 326. To this end, the client application 329 can include a browser, a dedicated application, or other executable, and the user interface 100 can include a network page, an application screen, or other user mechanism for obtaining user input. The client device 304 can be configured to execute applications beyond the client application 329 such as email applications, social networking applications, word processors, spreadsheets, or other applications.

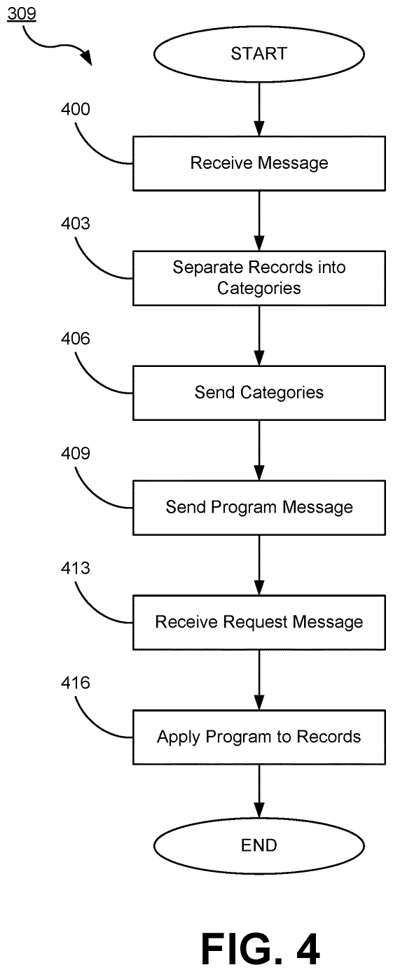

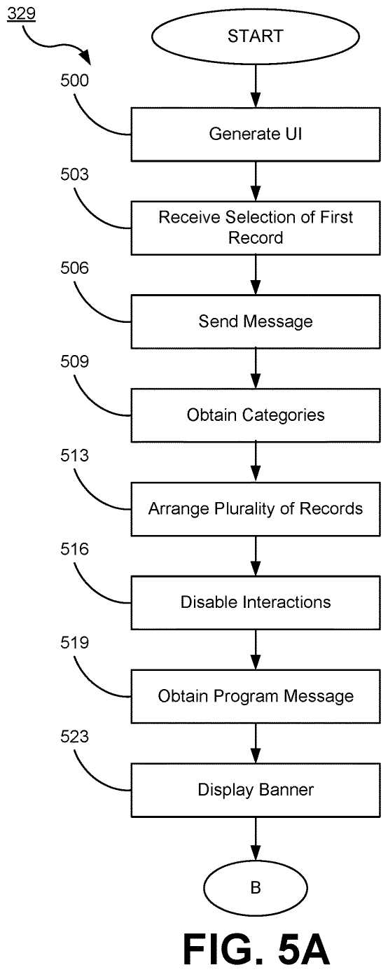

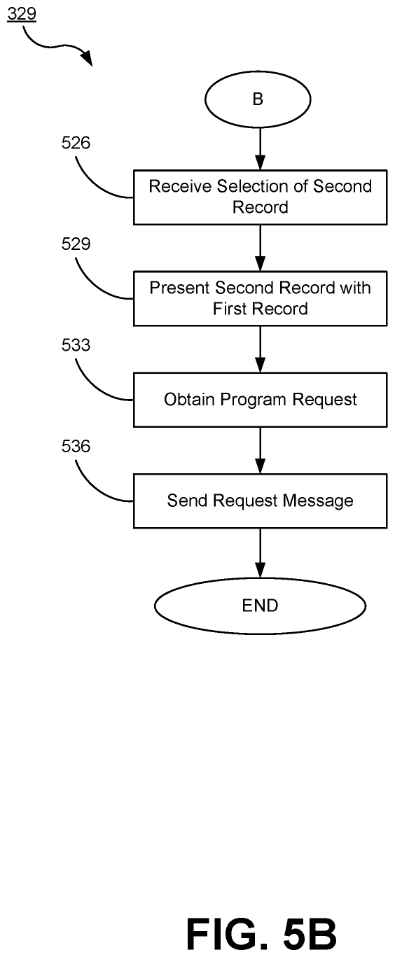

Next, a general description of the operation of the various components of the network environment 300 is provided. Although the following description provides merely an example of the operation of the various components of the network environment 300, other interactions and operations can also be performed by the various embodiments of the present disclosure. More detailed description of the operation of individual components is illustrated in the flowcharts of FIGS. 4-5.

To begin, an issuer of a client account 312 can design one or more programs 310 to encourage client engagement in a particular sector. When a user interacts with the client application 329, a banner 106 comprising an advertising message about a particular program 310 can be presented through a user interface 100. In some embodiments, the program 310 advertised in the banner 106 is selected based at least in part on client account data 316 associated with the client account 312. In some embodiments, the program 310 advertised in the banner 106 is selected based at least in part on the records 311 associated with the client account 312. In some embodiments, the program 310 advertised in the banner 106 is selected based at least in part on the program data 323 of the program 310.

Next, a user can interact with various user interface elements 116 of the user interface 100. According to various examples, a user can select a user interface element 116 within the banner 106 describing the program 310, a user interface element 116 associated with a particular record 311, or another user interface element 116 in order to select a program 310. Upon receiving interactions with the user interface elements 116, the client application 329 can cause the presentation of records 311 in the user interface 100 to automatically rearrange based at least in part on the qualification criteria 324 of the program 310 and the record data 319 associated with individual records 311. A user can interact with a user interface element 116 associated with a record 311 in a first category 109a, and cause interactions with user interface elements 116 of records 311 in a second category 109b to be disabled.

Further, the user can select one or more records 311 from the same category 109. In some embodiments, if the selected records 311 meet the qualification criteria 324 of the program 310, then the user can proceed to request that the program 310 be applied to the selected records 311.

Referring next to FIG. 4, shown is a flowchart that provides one example of the operation of a portion of the program service 309. The flowchart of FIG. 4 provides merely an example of the many different types of functional arrangements that can be employed to implement the operation of the depicted portion of the program service 309. As an alternative, the flowchart of FIG. 4 can be viewed as depicting an example of elements of a method implemented within the network environment 300.

Beginning with block 400, the program service 309 can receive a message. In some embodiments, the program service 309 can receive a message from the client application 329. The message can be representative of an input, request, instruction, order, or other notification from the client application 329 which indicates to the program service 309 that a record 311 has been selected. In some examples, the program service 309 obtains the message from a data store 313.

At block 403, the program service 309 can separate a plurality of records 311 into categories. The program service 309 can obtain the plurality of records 311 from a data store 313, the client application 329, or another system, service, or application in the network environment 300. In some embodiments, the program service 309 separates the plurality of records 311 in response to receiving the message at block 400. The program service 309 can separate the plurality of records 311 according to whether or not individual records 311 satisfy qualification criteria 324 of a particular program 310. In some embodiments, the program service 309 can determine the program 310 to use from the message received at block 400. In some embodiments, the program service 309 can obtain the program 310 and corresponding qualification criteria 324 from a data store 313. According to various examples, the program service 309 can generate a list of subcategories of records 311, wherein different subcategories contain records 311 which qualify or do not qualify for various programs 310.

At block 406, the program service 309 can send the separated categories to another application. In some embodiments, the program service 309 sends the separated categories to the client application 329. In some embodiments, the program service 309 sends the separated categories to a data store 313 or another system, service, or application in the network environment 300. The program service 309 can send the separated categories upon completion of separating the categories at block 403. According to various examples, the program service 309 can send the separated categories in response to a request for the categories.

At block 409, the program service 309 can be executed to send a program message. The program message can be representative of an input, request, instruction, order, or other notification which includes program data 323 associated with a preferred program 310. The program service 309 can determine which program 310 is to be used for the program message based at least in part on the program data 323 and, in some embodiments, based at least in part on client account data 316, or other data. For example, the program service 309 can determine the program 310 by comparing client account data 316 to the program data 323 associated with various programs 310 and select the program 310 with program data 323 having the closest correspondence to the client account data 316. In some examples, the program service 309 can determine the preferred program 310 based at least in part on a message received from another system, service, or application in the network environment 300. In some embodiments, the program service 309 can send the program message to the client application 329, to a data store 313, or to another system, service, or application in the network environment 300.

At block 413, the program service 309 can be configured to receive a request message. In some embodiments, the program service 309 can receive the request message from the client application 329. The request message can include record data 319 associated with one or more records 311. The request message can identify one or more records 311 selected by a user and include record data 319 associated with the selected records 311. According to various examples, the request message can be an instruction to the program service 309 to apply a program 310 to the selected records 311. In some embodiments, the program service 309 can obtain the request message from a data store 313 or other system, service, or application.

At block 416, the program service 309 can apply a program 310 to records 311. The program service 309 can apply the program 310 which was used at block 403 to separate the records 311 into categories. The program service 309 can apply the program 310 to the selected records 311 identified in the request message received at block 413. In some examples, applying the program 310 to the records 311 can be adding an award to a booking, applying a discount to a transaction, including a special offer for an order, etc. After block 416, the flowchart of FIG. 4 comes to an end.

Turning now to FIGS. 5A and 5B, shown is a flowchart that provides one example of the operation of a portion of the client application 329. The flowchart of FIGS. 5A and 5B provides merely an example of the many different types of functional arrangements that can be employed to implement the operation of the depicted portion of the client application 329. As an alternative, the flowchart of FIGS. 5A and 5B can be viewed as depicting an example of elements of a method implemented within the network environment 300.

Beginning with block 500, the client application 329 can generate a user interface 100. In some embodiments, the user interface 100 can include the information, plurality of records 311, and user interface elements 116 described in the discussion of FIGS. 1 and 2. The client application 329 can generate the user interface 100 on a display 326 of a client device 304.

At block 503, the client application 329 can receive a selection of a first record 311. The selection can be obtained, for example, through a user interaction with a user interface element 116 as depicted in FIGS. 1 and 2. However, other user interactions could also indicate a selection of a first record 311.

At block 506, the client application 329 can send a message. According to various examples, the client application 329 can send a message containing the selected record 311 obtained at block 503 and associated record data 319 to the program service 309. The message can be representative of an input, request, instruction, order, or other notification which indicates that a record 311 has been selected. In some embodiments, the client application 329 can send the message to a data store 313, or other system, service, or application in the network environment 300.

At block 509, the client application 329 can obtain categories or subcategories of records 311. The client application 329 can obtain the categories from the program service 309, from a data store 313, or from another system, service, or application in the network environment 300. In some embodiments, the categories obtained have been separated according to whether each record 311 satisfies the qualification criteria 324 for a particular program 310.

At block 513, the client application 329 can arrange the plurality of records 311. The client application 329 can automatically arrange the plurality of records 311 presented in the user interface 100 based at least in part upon the categories obtained at block 509. In some embodiments, the client application 329 can arrange the plurality of records 311 as shown in the examples of FIGS. 1 and 2. In some embodiments, the client application 329 can automatically arrange the plurality of records 311 based at least in part on a user interaction with a user interface element 116 of the user interface 100. In some embodiments, the client application 329 can arrange components in the user interface 100 other than the plurality of records 311.

At block 516, the client application 329 can disable interactions with one or more categories of records 311 in the user interface 100. In some embodiments, the client application 329 can disable interactions in response to receiving a user interaction. For example, the client application 329 can disable interactions with all records 311 in a program-unqualified category in response to receiving a user interaction with a user interface element 116 of a record 311 in a program-qualified category, as described in the discussion of FIG. 2. In some embodiments, the client application 329 can automatically disable interactions with records 311 in a category based at least in part on the selection received at block 503.

Moving to block 519, the client application 329 can be executed to obtain a program message. The program message can be representative of an input, request, instruction, order, or other notification which includes program data 323 associated with a preferred program 310. In some embodiments, the client application 329 can obtain the program message from the program service 309, a data store 313, or another system, service, or application in the network environment 300.

At block 523, the client application 329 can display a banner 106. The client application 329 can generate and display a banner 106 in the user interface 100 as described in the discussion of FIGS. 1 and 2. In some embodiments, the banner 106 can represent a message including program data 323 and advertising a program 310. The banner 106 can include a user interface element 116 allowing a user to select a program 310, apply a program 310 to selected records 311, link to more information, or interact with another feature in the user interface 100. In some embodiments, the banner 106 can include the program message received at block 519. The client application 329 can display the banner 106 in response to receiving the program message at block 519, in response to a user interaction with a user interface element 116, or automatically.

Moving next to block 526 in FIG. 5B, the client application 329 can receive a selection of at least a second record 311. The selection can be obtained, for example, through a user interaction with a user interface element 116 as depicted in FIGS. 1 and 2. However, other user interactions could also indicate a selection of a second record 311. In some embodiments, the client application 329 can receive selections of multiple records 311.

At block 529, the client application 329 can present the second record 311 with the first record 311. The client application 329 can automatically rearrange the first record 311 and the second record 311 in the user interface 100 to present them together in a group. In some examples, the client application 329 can rearrange the plurality of records 311 in the user interface 100 such that each selected record 311 is presented in a group separate from the un-selected records 311. According to various examples, the selected records 311 are presented together in a subsequent user interface 100 such as a new window, pop-up, page, or screen. In some embodiments, the client application 329 can cause the selected records 311 to move to the top of a list of records 311, where un-selected records 311 are presented at the bottom of the list.

Next, at block 533, the client application 329 can obtain a program request. The program request can be representative of an indication, a message, a prompt, an instruction, or a notification to the client application 329. The program request can be obtained, for example, through a user interaction with a user interface element 116 as depicted in FIGS. 1 and 2. However, other user interactions could also initiate a program request. In some embodiments, the client application 329 can obtain the program request from a data store 313 or another system, service, or application in the network environment 300.

At block 536, the client application 329 can be configured to send a request message. The request message can include record data 319 associated with one or more records 311. The request message can identify one or more records 311 selected by a user and include record data 319 associated with the selected records 311. According to various examples, the request message can be an instruction to the program service 309 to apply a program 310 to the selected records 311. In some embodiments, the client application 329 can send the request message to the program service 309, or other system, service, or application in the network environment 300. After block 536, the flowchart of FIGS. 5A and 5B comes to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 303.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
arrange a plurality of records in a user interface based at least in part on a program-qualified category and a program-unqualified category in response to a first selection of a first record;
disable interactions with user interface elements corresponding to records associated with the program-unqualified category such that user interaction is restricted to interactions with records in the program-qualified category;
obtain a program message, the program message comprising program data associated with a program for which the records in the program-qualified category are qualified; and
display a banner, the banner comprising a user interface element describing the program.

2. The system of claim 1, wherein the machine-readable instructions further cause the computing device to at least:
receive a selection of at least one qualified record from the program-qualified category; and
present, within the user interface, a selected at least one qualified record with the first record to form a group of selected records.

3. The system of claim 2, wherein the machine-readable instructions further cause the computing device to at least:
obtain a program request through the user interface, the program request representing a request to apply a program to the group of selected records; and
send a request message to a program service, the request message comprising record data associated with the group of selected records.

4. The system of claim 1, wherein the program data comprises at least one of a program rate, a duration of the program, a qualified enterprise, or a qualified record type.

5. The system of claim 1, wherein the machine-readable instructions further cause the computing device to at least:
send a message to a program service, the message comprising record data associated with the first record, wherein the record data comprises at least one of an enterprise identifier, a record type, or a record value.

6. The system of claim 1, further comprising:
obtain, from a program service, a second program-qualified category of the plurality of records, and a second program-unqualified category of the plurality of records, the second program-qualified category of the plurality of records comprising at least a third record, wherein the third record meets at least a second qualification criterion for a second program.

7. The system of claim 1, wherein the machine-readable instructions that cause the computing device to disable interactions with the user interface elements further cause the computing device to at least:
automatically disable interactions with the user interface elements based at least in part on the first selection of the first record.

8. A method, comprising:
arranging a plurality of records in a user interface based at least in part on a program-qualified category and a program-unqualified category in response to a first selection of a first record;
disabling interactions with user interface elements corresponding to records associated with the program-unqualified category such that user interaction is restricted to interactions with records in the program-qualified category;
obtaining a program message, the program message comprising program data associated with a program for which the records in the program-qualified category are qualified; and
displaying a banner, the banner comprising a user interface element describing the program.

9. The method of claim 8, further comprising:
receiving a selection of at least one qualified record from the program-qualified category; and
presenting, within the user interface, a selected at least one qualified record with the first record to form a group of selected records.

10. The method of claim 9, further comprising:
obtaining a program request through the user interface, the program request representing a request to apply a program to the group of selected records; and
sending a request message to a program service, the request message comprising record data associated with the group of selected records.

11. The method of claim 8, wherein the program data comprises at least one of a program rate, a duration of the program, a qualified enterprise, or a qualified record type.

12. The method of claim 8, further comprising:
sending a message to a program service, the message comprising record data associated with the first record, wherein the record data comprises at least one of an enterprise identifier, a record type, or a record value.

13. The method of claim 8, further comprising:
obtaining, from a program service, a second program-qualified category of the plurality of records, and a second program-unqualified category of the plurality of records, the second program-qualified category of the plurality of records comprising at least a third record, wherein the third record meets at least a second qualification criterion for a second program.

14. The method of claim 8, wherein disabling interactions with user interface elements further comprises:
automatically disabling interactions with the user interface elements based at least in part on the first selection of the first record.

15. A non-transitory, computer-readable medium, comprising machine-readable instructions that, when executed by a processor of a computing device, cause the computing device to at least:
arrange a plurality of records in a user interface based at least in part on a program-qualified category and a program-unqualified category in response to a first selection of a first record;
disable interactions with user interface elements corresponding to records associated with the program-unqualified category such that user interaction is restricted to interactions with records in the program-qualified category;
obtain a program message, the program message comprising program data associated with a program for which the records in the program-qualified category are qualified; and
display a banner, the banner comprising a user interface element describing the program.

16. The non-transitory, computer-readable medium of claim 15, wherein the machine-readable instructions further cause the computing device to at least:
receive a selection of at least one qualified record from the program-qualified category; and
present, within the user interface, a selected at least one qualified record with the first record to form a group of selected records.

17. The non-transitory, computer-readable medium of claim 16, wherein the machine-readable instructions further cause the computing device to at least:
obtain a program request through the user interface, the program request representing a request to apply a program to the group of selected records; and
send a request message to a program service, the request message comprising record data associated with the group of selected records.

18. The non-transitory, computer-readable medium of claim 15, wherein the program data comprises at least one of a program rate, a duration of the program, a qualified enterprise, or a qualified record type.

19. The non-transitory, computer-readable medium of claim 15, wherein the machine-readable instructions further cause the computing device to at least:
send a message to a program service, the message comprising record data associated with the first record, wherein the record data comprises at least one of an enterprise identifier, a record type, or a record value.

20. The non-transitory, computer-readable medium of claim 15, wherein the machine-readable instructions further cause the computing device to at least:
obtain, from a program service, a second program-qualified category of the plurality of records, and a second program-unqualified category of the plurality of records, the second program-qualified category of the plurality of records comprising at least a third record, wherein the third record meets at least a second qualification criterion for a second program.
